(19) United States
(12) Patent Application Publication
(10) Pub. No.: US 2014/0367517 A1
(43) Pub. Date: Dec. 18, 2014

(54) Aircraft Galley and Lighting System

(71) Applicant: B/E AEROSPACE, INC., Wellington, FL (US)

(72) Inventors: David P. Eckel, Fort Salonga, NY (US); William H. Valentine, Jr., Commack, NY (US)

(21) Appl. No.: 13/919,839

(22) Filed: Jun. 17, 2013

(51) Int. Cl. B64D 47/02; B64D 11/04

(52) U.S. Cl. CPC B64D 47/02; B64D 11/04
USPC 244/118.5; 362/470

(57) ABSTRACT

An aircraft galley, according to one implementation, includes a lighting system having a DC, linear LED task light that is positioned in a groove along the edge of an overhang above the galley's work surface. The task light is oriented downward orthogonally to the cabin floor so as to illuminate a work surface of the galley. In some implementations, the task light is angled so that it illuminates the work surface of the galley in which it is installed, the forward, aft, or cross-aisle opposing galley, if applicable, and the floor.

### BACKGROUND

The disclosure relates generally to aircraft galleys and, more specifically, to aircraft galleys with integrated lighting systems.

### SUMMARY

Commercial airlines rely heavily on business and first class passengers to maximize profits on long-haul flights. Because such passengers pay many times the price of a coach seat, airlines try to make their in-flight experience as luxurious as possible. One element of creating an atmosphere of luxury is proper cabin lighting. Making improvements to cabin lighting is challenging. Aircraft manufacturers have strict requirements for aircraft lighting, which are based partly on weight and power limitations and partly on federal regulations.

### BRIEF DESCRIPTION OF THE DRAWINGS

While the appended claims set forth the features of the present techniques with particularity, these techniques may be best understood from the following detailed description taken in conjunction with the accompanying drawings of which:

FIG. 1 shows a perspective view of the aircraft galley and lighting system.

FIG. 2 shows a cross-sectional view along line 101 of FIG. 1

FIG. 3 shows an enlarged view of the section labeled 131 in FIG. 2.

FIG. 4 shows the view of FIG. 2 without the insert 104.

FIG. 5 shows an enlarged view of the section labeled 133 in FIG. 4.

FIG. 6 shows a frontal view and an elevated view of the aircraft galley and lighting system.

FIG. 7 through FIG. 14 show illumination diagrams and lighting configurations according to various embodiments, with the view being that of the work surface.

### DETAILED DESCRIPTION

The aircraft galley described herein can be implemented in a variety of ways. Similarly, the aircraft galley's lighting system has many possible configurations. In an embodiment, the galley includes a lighting system having a DC, linear LED task light that is positioned in a groove along the edge of an overhang above the galley's work surface. In one embodiment, the task light is oriented downward orthogonally to the cabin floor. In some embodiments, the task light is angled so that it illuminates the work surface of the galley in which it is installed, the forward, aft, or cross-aisle opposing galley, and the floor. In one implementation, the task light is oriented to as to illuminate an opposing half galley, including doors, cabinets, latches, and surfaces. In one embodiment, the task light includes multiple, individual LED lights housed in an aluminum extrusion. The task light may be configured and calibrated so as to provide an even wash, even intensity, and even color, with the resulting effect being that a person viewing the galley area of the aircraft does not see multiple independent lights, but rather a single, even light. This lighting scheme can provide the galley with a high-end, high-quality look.

Examples of where embodiments of the galley and lighting system described herein may be used include Door 2 and Door 4 of a Boeing™ 777-300 or 777-300ER, both of which accommodate a half-galley.

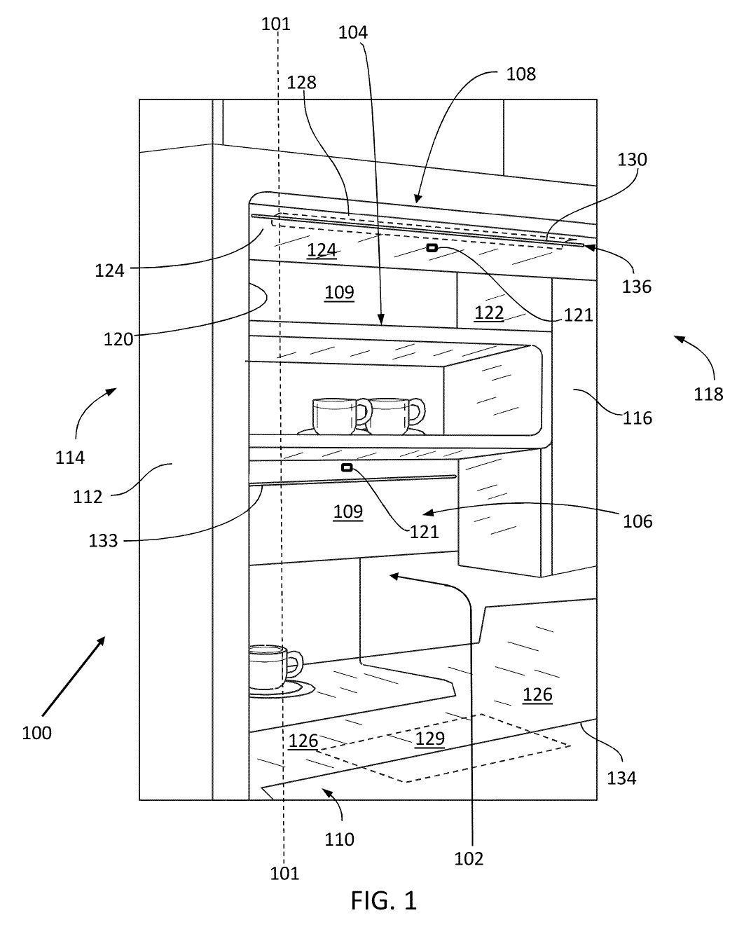

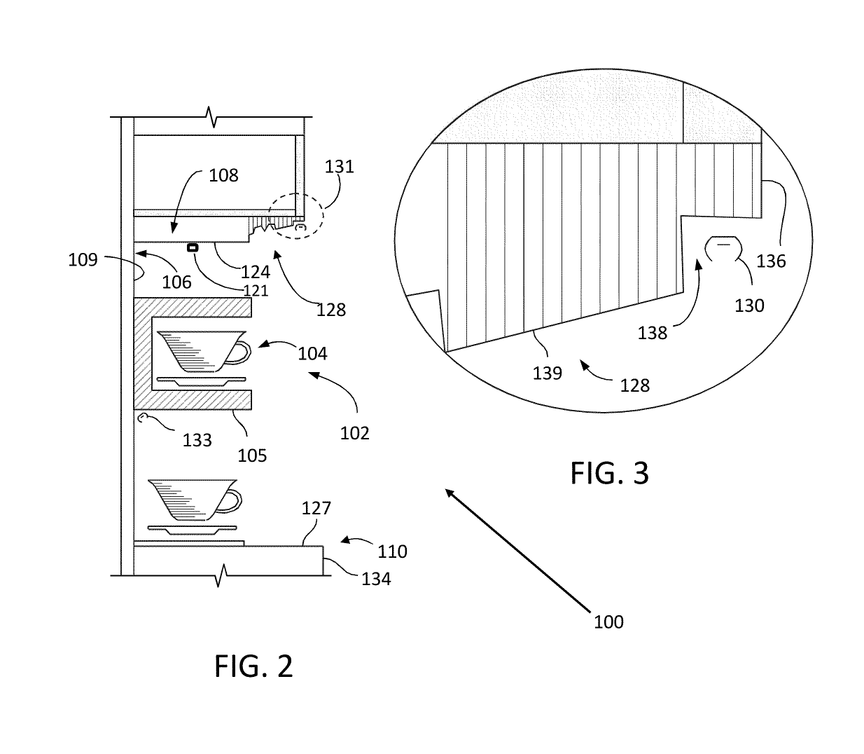

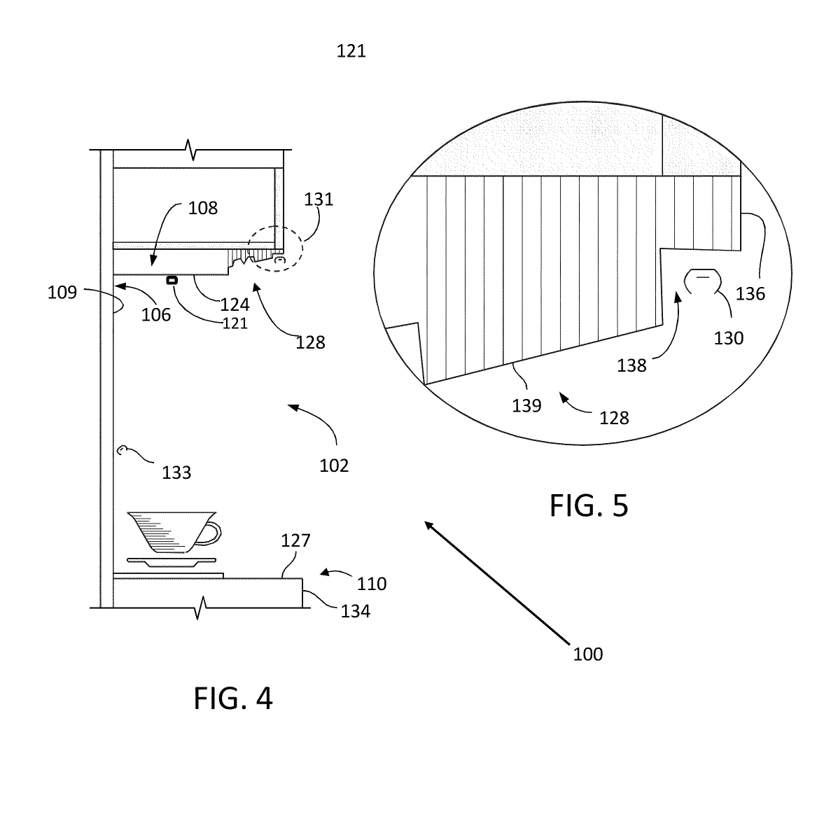

Referring to FIG. 1 through FIG. 5, an embodiment of the aircraft galley will now be described. The aircraft galley, generally labeled 100, has a rear wall 106, a roof 108, and a shelf 110. The galley 100 also has a first side wall 112 on a first side 114 of the galley 100, and a second side wall 116 on a second side 118 of the galley 100. The galley 100 has a recess 102 that is defined by a rear surface 109, an upper surface 124, a work surface 126, a first side inner surface 120, and a second side inner surface 122. The rear surface 109 is an inner surface of the rear wall 106; the upper surface 124 is a lower surface of the roof 108; the work surface 126 is an upper surface of the shelf 110; the first side inner surface 120 is an inner surface of the first side wall 112; and the second side inner surface 122 is an inner surface of second side wall 116.

The work surface 126 provides a space for the cabin crew to perform galley-related work, such as pouring drinks and preparing food.

The galley 100 also has an overhang 128 extending from the roof 108. The overhang 128 has a groove 138 on its underside 139 near a front edge 136 of the overhang 128. The groove 138 runs along the length of the galley 100 from the first side 114 to toward the second side 118, though not necessarily the entire length and not necessarily in a single, uninterrupted piece. The task light 130 may or may not use the groove 138 as a heat sink.

The front edge 136 of the overhang 128 and the front edge 134 of the shelf 110 define the mouth of the recess 102. Accordingly, the front edge 134 of the overhang 128 constitutes the top, front edge of the mouth of the recess 102.

Additionally, the galley 100 has a lighting system that includes a task light 130 attached to the overhang 128 within the groove 138. The task light 130 is oriented downward to illuminate the work surface 126.

The recess 102 is configured to receive an insert 104 (a.k.a. appliance). The insert 104 is usable by a flight crew to perform a function relating aircraft passenger service. When in the recess, the insert 104 is positioned such that a lower surface 105 of the insert faces the work surface 126 of the recess 102. Although the insert 104 is depicted as a shelf, it may be any of a variety of types of inserts. Example inserts include an oven, coffee maker, shelf, chiller, or cabinet. In some embodiments, the lower surface 105 of the insert 104 is reflective, and may have lights attached thereto. The task light 130 may also illuminate the insert 104. However, in some embodiments, a ceiling/roof light provides supplemental illumination on an upper portion of the insert 104. FIG. 3 shows the galley 100 with no insert.

Referring still to FIG. 1 through FIG. 5, the lighting system of the galley 100 further includes a supplemental light 133 disposed on the rear surface 109 under a portion of the recess 102 in which the insert 104 is received. The supplemental light 133, which may be recessed, is configured to directed light toward the mouth of the recess and at least partially onto the work surface 126. In some embodiments, the supplemental light 133 is elongated and runs along the rear surface 109. The lighting system further includes one or more point source lights 121. The point source light 121 provides further supplemental lighting and can, for example, remain lit even when the task light 130 supplemental light 133. FIG. 1 shows a point source light 121 in different possible locations. It may be positioned in other places as well.

The task light 130 and supplemental light 133 may be dimmable from 100% to 0%. Dimming controls may be located locally as a Human Machine Interface (HMI). They may also be located remotely from the lights. In one implementation, the task light 130 and the supplemental light 133 maintain less than a 4:1 contrast ratio.

In one embodiment, the supplemental light 133 includes an elongated light assembly and is oriented along a plane that plane is substantially parallel to the rear surface 109. Also in this embodiment, the task light 130 includes an elongated light assembly that is oriented along another plane that is substantially parallel to the plane of the supplemental light 133.

Either or both of the task light 130 and the supplemental light 133 may be symmetric or asymmetric, and may have varying lens designs including that that are scalloped, collimated, etc. In some embodiments, the task light 130 also has a secondary close out lens. Either or both lights may also have a frosted lens to smooth out any differences among the different, independent LED lights.

Either or both of the task light 130 and the supplemental light 133 may be implemented as line-replaceable units (LRUs) such as those described in U.S. Pat. No. 8,378,595, which is incorporated herein by reference in its entirety.

In some embodiments, the work surface 126 also includes an extendable work surface extension 129 coupled to the work surface 126. The work surface extension 129 provides an additional surface on which the cabin crew can perform passenger service-related tasks. In those embodiments, when the work surface extension is extended, the task light 130 illuminates it as well.

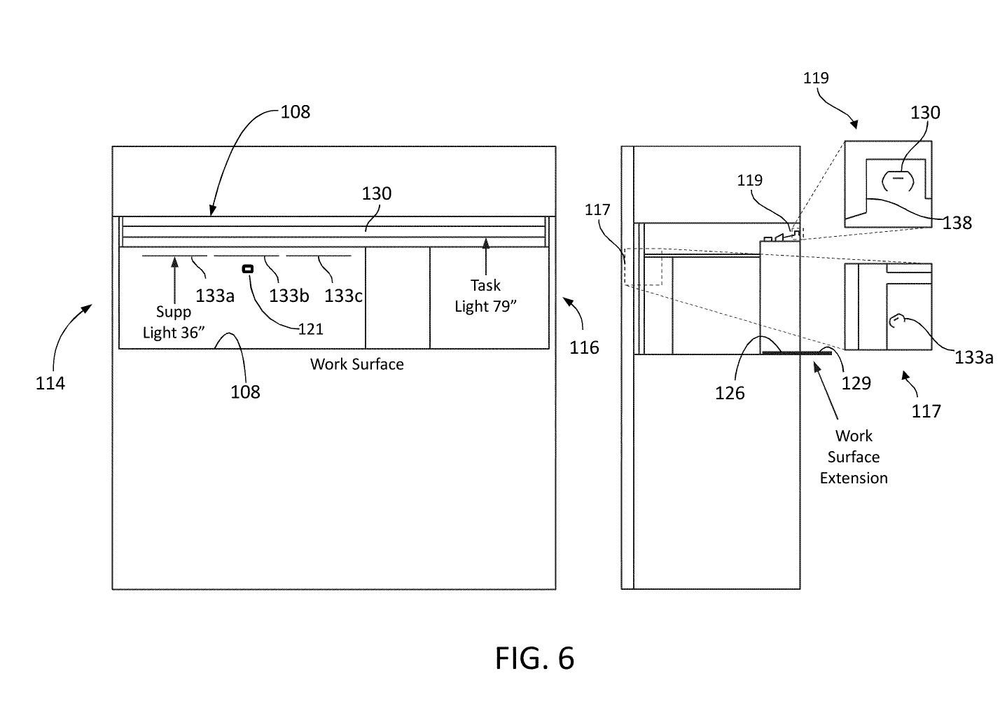

In the embodiment of FIG. 6 the galley 100 has a lighting system that includes a 79 inch task light 130 and three supplemental lights—a first supplemental light 132A, a second supplemental light 132B, and a third supplemental light 132C. In one embodiment, each of the first, second, and third supplemental lights is a 12 inch unit of the type described in U.S. Pat. No. 8,378,595. Each of the supplemental lights 132A, 132B, and 132C has the same function and possible configurations as the supplemental light 132 previously described.

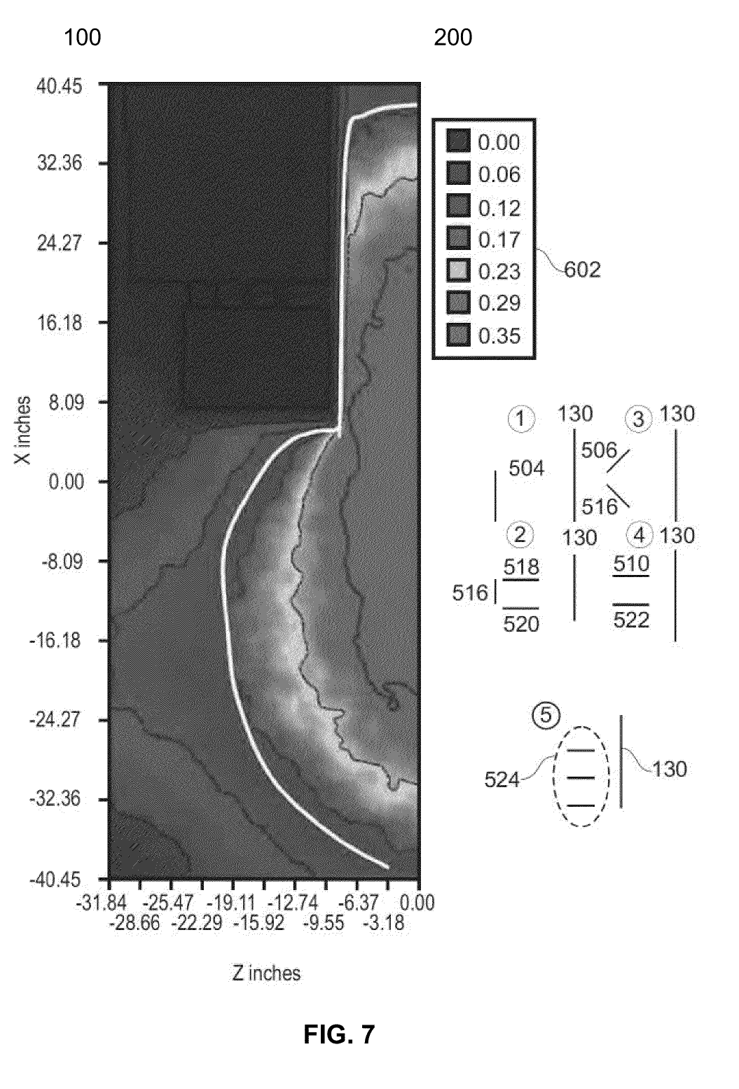

Referring to FIG. 7, alternatives to the supplemental light 133 are shown. Each of these configurations may include the point source light 121 In one configuration, a first side light 518 is disposed on the first interior side surface 120, and a second side light 520 is disposed on the second interior side surface 122. Each of the first and second side lights is oriented orthogonally to the rear surface 109.

Another configuration includes a supplemental light 516 is disposed on the rear surface 109 and orthogonal to the first side light 518 and the second side light 520.

In still another configuration, a first supplemental light 506 and a second supplemental light 516 are disposed on the rear surface 109. In this configuration, the first supplemental light 506 and the second supplemental light 516 are adjacent to one another, facing one another, and are each at a non-zero angle relative to the rear surface 109.

In another configuration, a set 524 of lights are disposed on the bottom of the insert 104 such that they are orthogonal to the task light 130. The set 524 of lights are oriented to illuminate the work surface 126.

In some embodiments, the galley 100 is implemented as a half galley, in which one side (e.g., the first side 114 or the second side 118) only extends to a floor surface. In other embodiments, the galley 100 is implemented as full galley, which includes a first half configured as shown in FIG. 1 through FIG. 5, and a second half that is positioned next to the first half. There are many possible configurations, however, including a U-shaped galley configuration, back-to-back galleys, and parallel galleys. In one embodiment, a second half galley includes the same elements as the first half, and the elements of the second half are positioned and configured in the same manner as the corresponding elements of the first half. There may be differences between the two halves, but the general configurations are the same between the two.

Additionally in FIG. 7, a lighting diagram shows the results in one embodiment of the illuminance on the work surface. The white line represents 0.14 lumens per square inch (20 foot-candles).

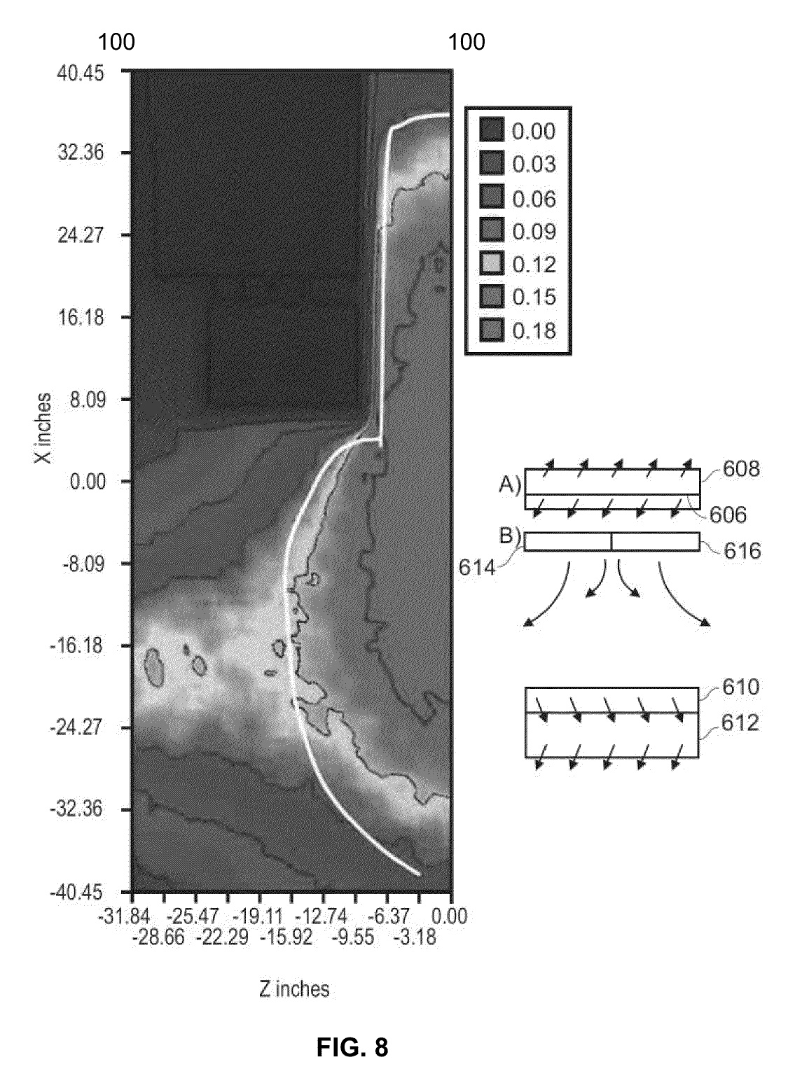

Referring to FIG. 8, other lens configurations are shown. In each of these configurations, there is a first lens and a second lens, and the views of the lenses shown in FIG. 8 are the views that would be seen if one looked into the recess 102 from the front of the galley 100 with an unobstructed view of the light (whether the task light or the supplemental light.) Either or both of the lenses in each configuration may be optical or non-optical. One or more of the lenses may be implemented as secondary close out lenses. Furthermore, one or more of the lenses could be a primary LRU lens or a secondary lens. For example, the primary might be optical and the secondary be non-optical, or vice versa. Finally, one or more of the lights provides illumination either in a direct manner or an indirect manner (e.g., reflecting off of the lower surface 105 of the insert 104).

In some embodiments, an angled LRU lens/asymmetric lens is used and configured so as to minimize the glare experienced by flight attendants as well on the HMI.

In one embodiment, one or both of the task light 130 and the supplemental light 133 have at least a first lens and a second lens. For example, a first lens configuration has a first lens 606 and a second lens 608. The first lens 606 is positioned below the second lens 608. The first lens 606 directs light downward and toward the first side 114 of the galley 100, and the second lens 608 provides indirect lighting in that it directs light upward toward the lower surface 105 of the insert 104 so as to reflect off of the lower surface 105. The second lens 608 directs light to the second side 118 of the galley 100. In lens configuration, it will be assumed that the lower surface 105 of the insert 104 is reflective. In one embodiment, the task or supplemental light is an LRU with an optical primary lens 608 and a non-optical secondary close out lens 606.

A second lens configuration has a first lens 610 and a second lens 612. The first lens 610 is positioned on top of the second lens 610. The first lens 610 directs light toward the first side 114 of the galley 100, and the second lens 612 directs light toward the second side 118 of the galley 100. In the second lens configuration, it will be assumed that the lower surface 105 of the insert 104 is reflective.

A third configuration has a first lens 614 and a second lens 616. The first lens 614 is next to the second lens 616. The first and second lenses direct light outwardly with respect to one another.

Additionally in FIG. 8, an illumination diagram along with a key is shown. The view is from the top onto the work surface. The diagram shows the results in one embodiment with a task light producing 100 lm/ft of illuminance on the work surface. The white line represents 0.14 lumens per square inch (20 foot-candles).

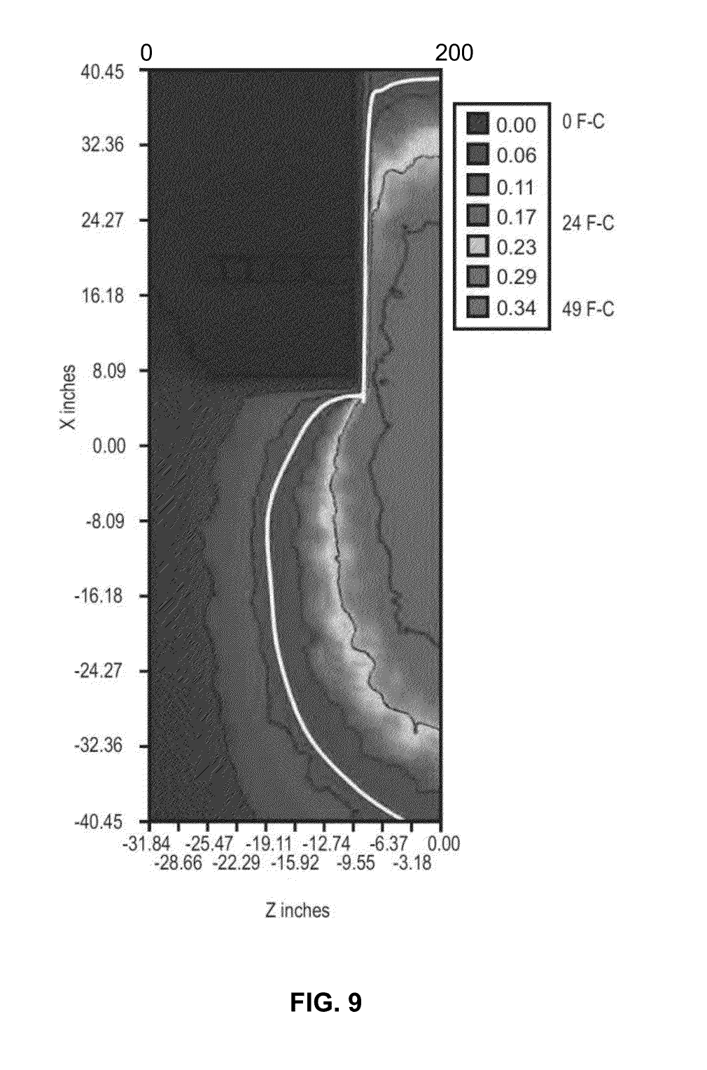

Referring to FIG. 9, an illumination diagram along with a key is shown. The view is from the top onto the work surface. In an embodiment, the linear lens extrusion (e.g., the straight line in front) may or may not be symmetrical. In an embodiment, ceiling area lights may be needed for the ends. Furthermore, a supplemental light may be needed. The luminance on the work surface: at the white line it is around 0.14 lumens per square inch (20 foot candles)

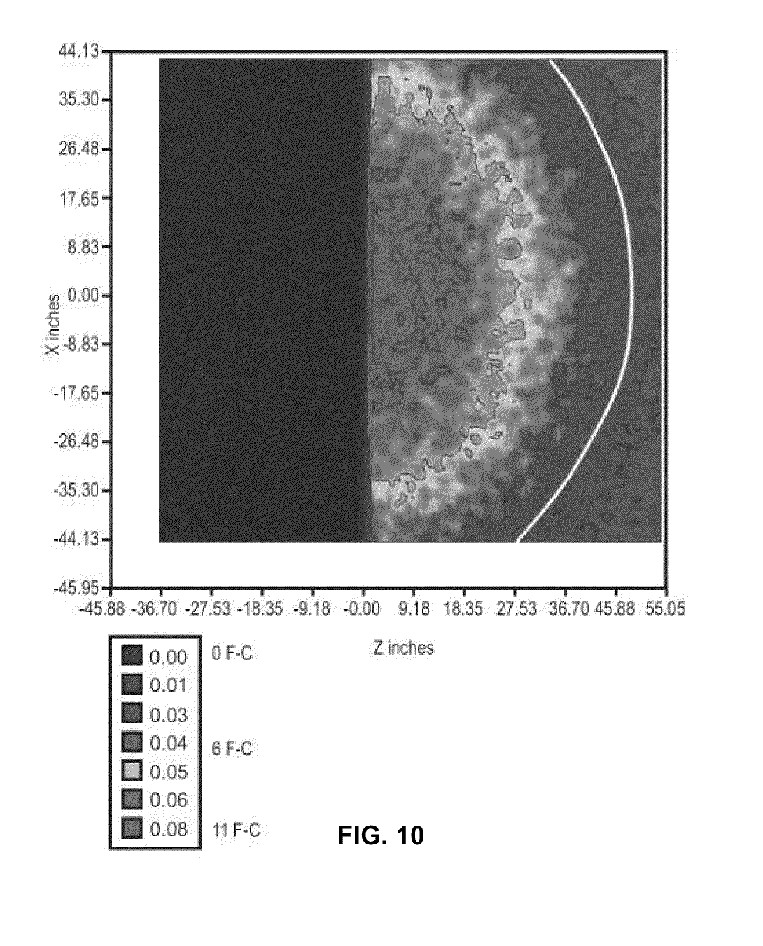

Referring to FIG. 10, an illumination diagram along with a key is shown. The view is from the top onto the floor. In this embodiment, a ceiling light may be needed. If both galley halves are present, then the required light output (e.g., by federal regulations) may be met. The ceiling light could just be accent lighting. The luminance on Door 2/4: at the white line it is around 0.0035 lumens per square inch (5 foot candles)

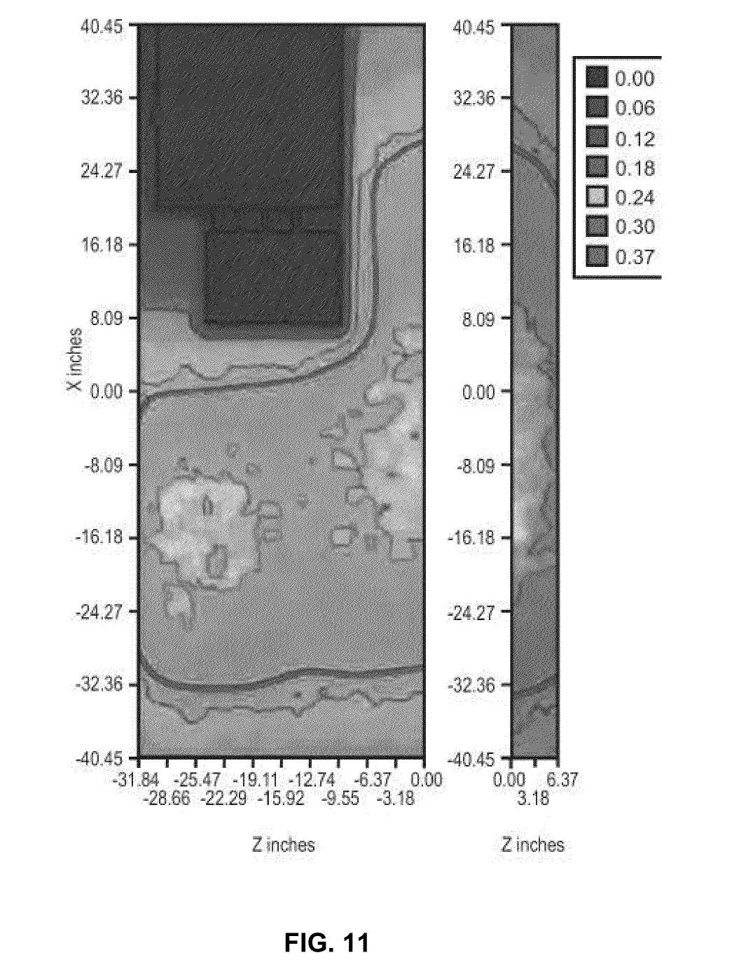

The embodiment of FIG. 11 shows the results if the task light is 100 lm/square foot and the supplemental light is 100 lm/square foot. The luminance on the work surface at the maroon line is 0.14 lumens per square inch (20 foot candles)

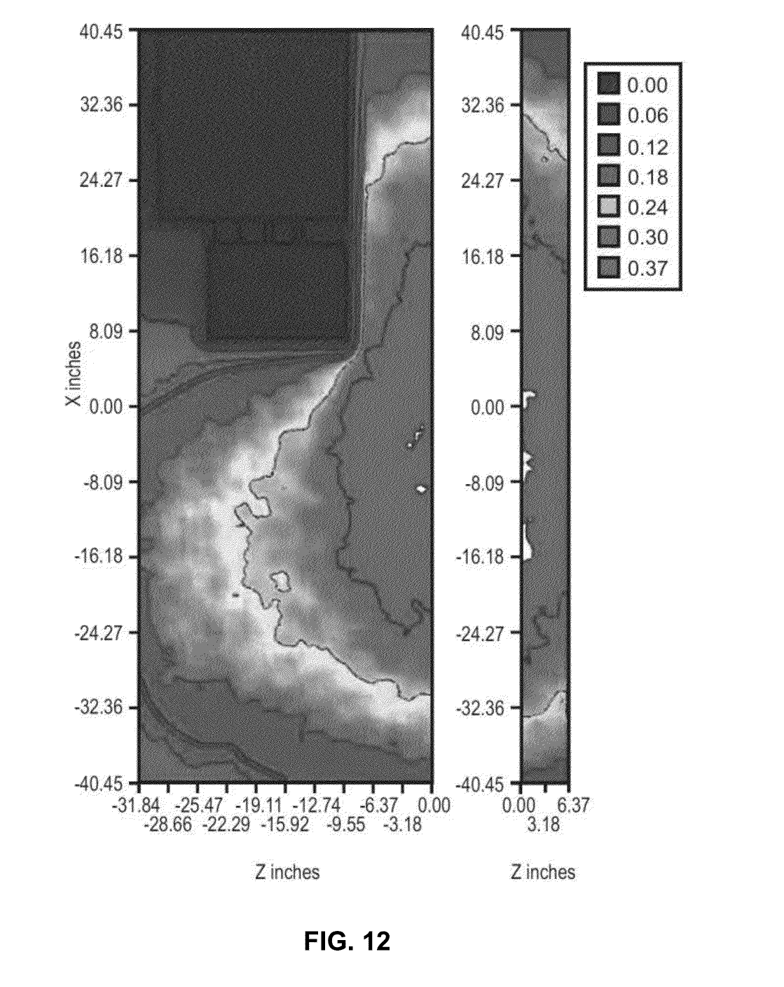

The embodiment of FIG. 12 shows the results if the task light is 200 lm/square foot and the supplemental light is 100 lm/square foot. The luminance on the work surface at the maroon line is 0.14 lumens per square inch (20 foot candles). The task light may be 79 inches and the supplemental light may be 36 inches.

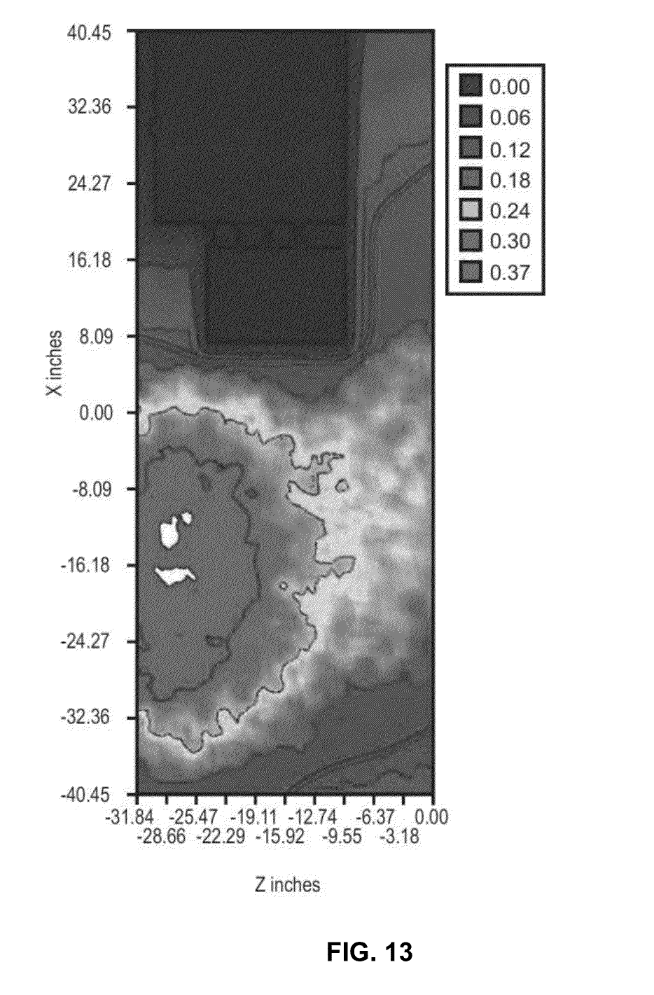

The embodiment of FIG. 13 shows the results if the task light is 100 lm/square foot and the supplemental light is 200 lm/square foot. The luminance on the work surface at the maroon line is 0.14 lumens per square inch (20 foot candles)

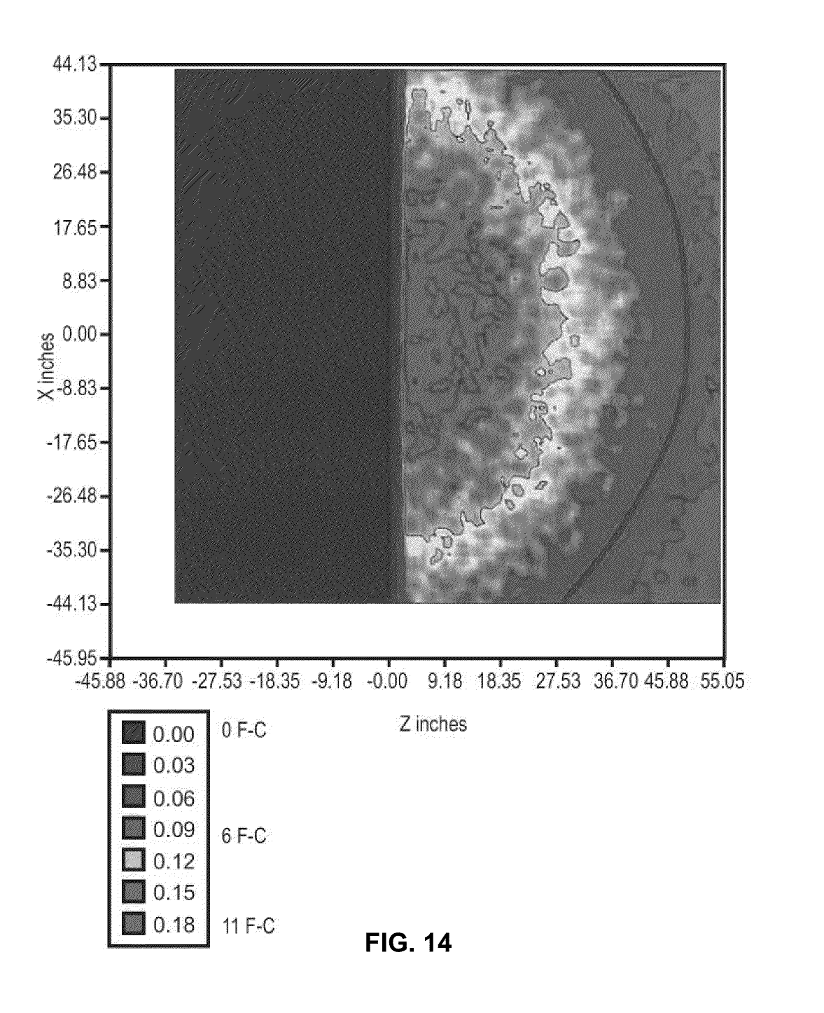

The embodiment of FIG. 14 shows the results if the task light is 200 lm/square foot and there is no supplemental light. The luminance predicted on the work surface at Door 2/4—the maroon line is 0.035 lumens per square inch (5 foot candles).

It can be seen from the foregoing that aircraft galley and lighting system has been provided. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

What is claimed is:

1. An aircraft galley having a recess, the aircraft galley comprising:
a rear wall, wherein an inner surface of the rear wall is a rear surface of the recess;
a roof, wherein a lower surface of the roof is an upper surface of the recess; and
a shelf, wherein an upper surface of the shelf is a lower surface of the recess, wherein
the upper surface faces the lower surface,
the rear surface faces a front side of the aircraft galley,
the recess is configured to receive an insert;
an overhang extending from the roof; and
a task light disposed on the overhang proximate to a front edge of the overhang, wherein the task light is oriented downward to illuminate the lower surface.

2. The aircraft galley of claim 1, wherein
the overhang has a groove that runs lengthwise along its front edge,
the task light is disposed within the groove.

3. The aircraft galley of claim 1, wherein
the lower surface includes a work surface,
the task light illuminates the work surface.

4. The aircraft galley of claim 1, wherein the lower surface includes a work surface, the aircraft galley further comprising:
a supplemental light disposed on the rear surface under a portion of the recess in which the insert is to be received,
wherein the supplemental light and the task light are both configured to direct light onto the work surface.

5. The aircraft galley of claim 4, wherein
the supplemental light comprises an elongated light assembly that is oriented along a first plane,
the first plane is substantially parallel to the rear surface,
the task light comprises an elongated light assembly that is oriented along a second plane,
the first plane is substantially parallel to the second plane.

6. The aircraft galley of claim 1, further comprising:
a first side wall, wherein an inner surface of the first side wall is a first interior side surface of the recess,
a second side wall, wherein an inner surface of the second side wall is a second interior side surface of the recess;
a first side light disposed on the first interior side surface, wherein the first side light is oriented orthogonally to the rear surface; and
a second side light disposed on the second interior side surface, wherein the second side light is oriented orthogonally to the rear surface.

7. The aircraft galley of claim 6, further comprising
a supplemental light disposed on the rear surface under a portion of the recess in which the insert is to be received.

8. The aircraft galley of claim 1, further comprising
a first supplemental light disposed on the rear surface under a portion of the recess in which the insert is to be received, wherein the first supplemental light is oriented at a non-zero angle with relative to the rear surface; and
a second supplemental light disposed on the rear surface adjacent to, and facing the first supplemental light.

9. The aircraft galley of claim 1, further comprising an insert received within the recess, wherein
the upper surface of the shelf serves as a work surface,
the task light illuminates the work surface,
a cabin ceiling light illuminates the work surface and the insert.

10. The aircraft galley of claim 1, further comprising:
a first half,
wherein recess and task light are part of the first half; and
a second half positioned next to the first half,
wherein the second half includes the same elements as the first half,
wherein the elements of the second half are positioned and configured in the same manner as the corresponding elements of the first half.

11. The aircraft galley of claim 1, wherein the upper surface of the shelf serves as a work surface, the aircraft galley further comprising:
an extendable work surface extension coupled to the work surface,
wherein the task light illuminates the work surface extension when extended.

12. The aircraft galley of claim 1, further comprising an insert received within the recess and positioned such that a lower surface of the insert faces the lower surface of the recess,
wherein the insert serves an airline passenger service function.

13. The aircraft galley of claim 12, wherein the insert is selected from a group consisting of:
an oven, a shelf, and a coffee maker, chiller, and cabinet.

14. The aircraft galley of claim 12, further comprising:
at least one light extending along a bottom surface of the insert.

15. A lighting system for an aircraft galley, the lighting system comprising:
a first LED wash light unit that runs along on a top, front edge of a recess of the galley,
wherein the first LED wash light unit is oriented downward to illuminate onto a work surface of the galley;
a second LED wash light unit that runs along a rear surface of the recess,
wherein the second LED wash light unit is configured to directed light toward a mouth of the recess and at least partially onto the work surface.

16. The lighting system of claim 15, wherein
at least one of the first LED wash light unit and the second LED wash light unit comprises a first lens and a second lens,
the first lens directs light from the LED wash light unit to a first side of the galley,
the second lens directs light from the LED wash light unit to a second side of the galley.

17. The lighting system of claim 15, wherein
at least one of the first LED wash light unit and the second LED wash light unit comprises a first lens and a second lens,
the first lens directs light from the LED wash light unit upward so as to reflect off of a lower surface of an insert of the galley,
the second lens directs light from the LED wash unit downward and toward a side of the galley.

18. The lighting system of claim 15, wherein
the first LED wash light unit is one of a plurality of LED wash light units that run along the top, front edge of a recess of the galley,
the second LED wash light unit is one of a plurality of LED wash lights that run along the rear surface of the recess.
